(19) United States
(12) Patent Application Publication
(10) Pub. No.: US 2002/0130802 A1
(43) Pub. Date: Sep. 19, 2002

(54) Combination high frequency circuit/infrared transmission circuit

(76) Inventor: Taddy Shao, Taipei Hsien (TW)

Correspondence Address: BACON & THOMAS, PLLC, 625 Slaters Lane, 4th Floor, Alexandria, VA, 22314-1176, US

(21) Appl. No.: 09/808,056

(22) Filed: Mar. 15, 2001

(51) Int. Cl. H04Q 7/00; G08B 1/08; G08C 19/16

(52) U.S. Cl. 341/176; 340/870.18

(57) ABSTRACT

A circuit assembly for a remote control is capable of learning (i.e., copying) and transmitting. The circuit assembly comprises a microprocessor, a memory, an oscillation generation circuit, a high frequency signal and frequency receiver circuit, a waveshaping circuit, a digital to analog converter (DAC), a voltage controlled oscillation frequency transmission circuit, a learning based infrared microprocessor control circuit, an infrared transmission circuit, an infrared receiver circuit, a key-in circuit, a power supply circuit, an LED indicator circuit, a voltage rectification circuit for high frequency circuit, and a high frequency circuit switch. The microprocessor can determine a signal sent from a pressed button, a frequency for high frequency wireless remote control, and calibrating frequency and performing a signal learning. Thereafter, the microprocessor is activated to issue an instruction to a corresponding electrical device through infrared or wireless for effecting a control.

### FIELD OF THE INVENTION

The present invention relates to remote controls and more particularly to a combination high frequency circuit/infrared transmission circuit of remote control which is capable of receiving (i.e., learning or copying) and transmitting through a simple operation.

### BACKGROUND OF THE INVENTION

Conventionally, remote controls are widely used in our daily life. For example, each of TV, VCR, VCD, Hi-Fi, air conditioner, fan, dehumidifier, microwave oven, electric lock, alarm, etc. is usually equipped with a remote control. Recently, an apparatus capable of controlling one or more electrical devices through voice has been developed and commercially available. However, as far as the present inventor knows that there is no universal remote control commercially available now except a so-called five-in-one remote control. In fact, such five-in-one remote control is only capable of activating devices through infrared. In other words, pieces of equipment such as fan, dehumidifier, microwave oven, electric lock, alarm, etc. are not capable of being activated by such remote control because they are designed to be operated through wireless only. This is not convenient. Thus it is common to find a variety of remote controls in a house. Further, the operating range of infrared remote control is limited. Furthermore, it is required to aim the remote control at remote control sensor of a corresponding electrical device for activation. Such remote control is advantageous for simple in construction. But above requirement for remote control to aim at remote control sensor is inconvenient. Thus, recently, a variety of wireless remote controls have been commercially available. Such wireless remote control is operable without the requirement of aiming remote control. However, the drawback of preparing a variety of remote controls has not been solved satisfactorily. Also, the combination of an infrared remote control and a wireless remote control into a single unit has not been disclosed in any documents.

Thus, it is desirable to provide a multifunctional remote control which combines a high frequency circuit and an infrared transmission circuit thereinto for effecting receiving (i.e., learning or copying) and transmitting through a simple operation in order to overcome the above drawbacks of prior art.

### SUMMARY OF THE INVENTION

It is an object of the present invention to provide a circuit assembly for a remote control. The circuit assembly comprises a microprocessor, a memory, an oscillation generation circuit, a high frequency signal and frequency receiver circuit, a waveshaping circuit, a digital to analog converter (DAC), a voltage controlled oscillation frequency transmission circuit, a learning based infrared microprocessor control circuit, an infrared transmission circuit, an infrared receiver circuit, a key-in circuit, a power supply circuit, a light emitting diode (LED) indicator circuit, a voltage rectification circuit for high frequency circuit, and a high frequency circuit switch wherein the microprocessor serves to determine a signal from the enabled key-in circuit, a frequency for high frequency wireless remote control, and sequentially change a frequency from the DAC until the frequency is equal to that of the memory for automatically calibrating frequency and performing a signal learning; the memory is implemented as random access memory (RAM), the memory is coupled to the microprocessor for storing signals sent from the high frequency signal and frequency receiver circuit for subsequent access by the microprocessor; the oscillation generation circuit serves to provide a stable operating frequency to the microprocessor; the high frequency signal and frequency receiver circuit serves to receive signals and send the same to the microprocessor for processing in a learning mode; the waveshaping circuit serves to amplify the signals sent from the high frequency signal and frequency receiver circuit and send the amplified signals to the microprocessor for processing; the DAC is commanded by the microprocessor to change voltage level and accordingly the frequency of the signals until which is equal to that stored in the memory; the voltage controlled oscillation frequency transmission circuit is coupled to the microprocessor and the DAC respectively wherein during learning, various continuous frequencies are sent from the DAC to the voltage controlled oscillation frequency transmission circuit for controlling the output oscillation frequency thereof, or a signal having a predetermined frequency is sent from the microprocessor directly to the voltage controlled oscillation frequency transmission circuit in a remote control mode; the power supply circuit serves to provide power required for high frequency transmission and infrared transmission circuit respectively; the voltage rectification circuit for high frequency circuit serves to provide a stable voltage for the microprocessor; the learning based infrared microprocessor control circuit serves to receive code sent from a corresponding electrical device or copy code during a high frequency wireless learning mode for enabling the learning based infrared microprocessor control circuit to determine instructions sent from the key-in circuit and controlling the electrical device to be activated through the infrared transmission circuit; the infrared transmission circuit is controlled by the learning based infrared microprocessor control circuit for transmitting infrared signals to control the electrical device, or learning signals indicated by the flashing of the LED indicator circuit are transmitted from the infrared transmission circuit during the learning mode; the infrared receiver circuit serves to receive the infrared signals and send the same to the learning based infrared microprocessor control circuit; and the high frequency circuit switch serves to switch between a high frequency transmission and an infrared transmission.

In one aspect of the present invention, the key-in circuit is directly coupled to the microprocessor whereby a predetermined button is pressed, the microprocessor is activated to issue an instruction to the corresponding electrical device through infrared or wireless for effecting a control.

The above and other objects, features and advantages of the present invention will become apparent from the following detailed description taken with the accompanying drawings.

### BRIEF DESCRIPTION OF THE DRAWINGS

FIG. 1 is a perspective view of a remote control combining a high frequency circuit and an infrared transmission circuit thereinto according to the invention;

FIG. 2 is a schematic circuit diagram of a first preferred embodiment of FIG. FIG. 3 is a block diagram of the FIG. 2 remote control; and

FIG. 4 is a block diagram of a second preferred embodiment of FIG. 1.

### DETAILED DESCRIPTION OF THE PREFERRED EMBODIMENTS

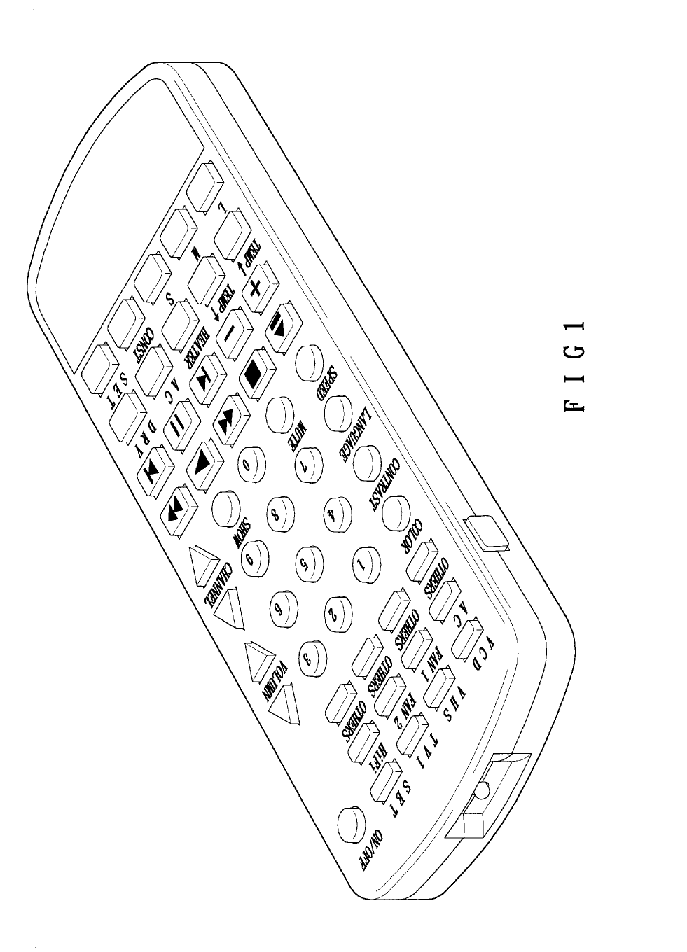

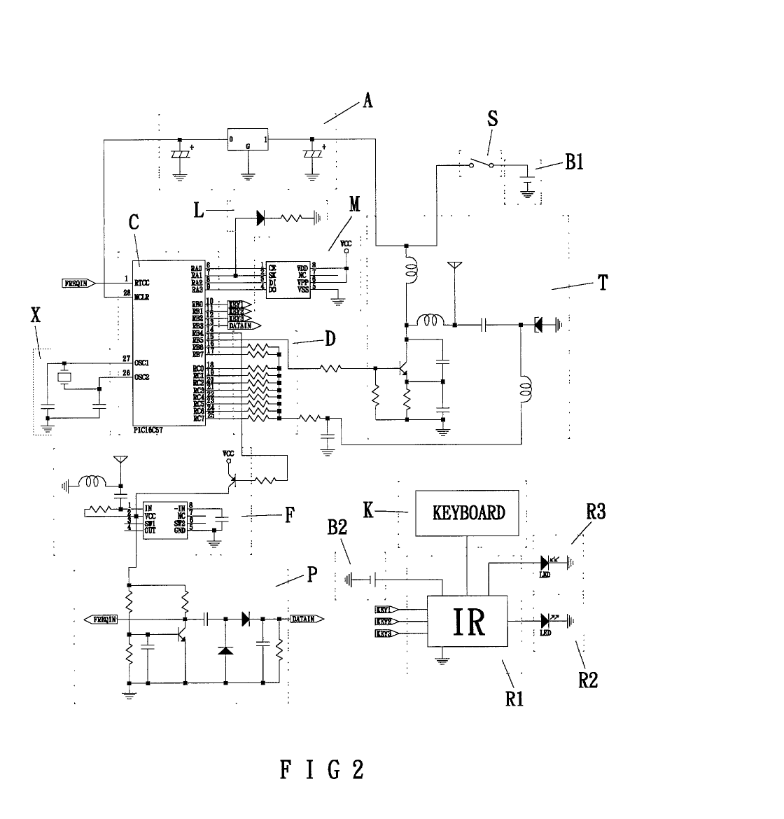

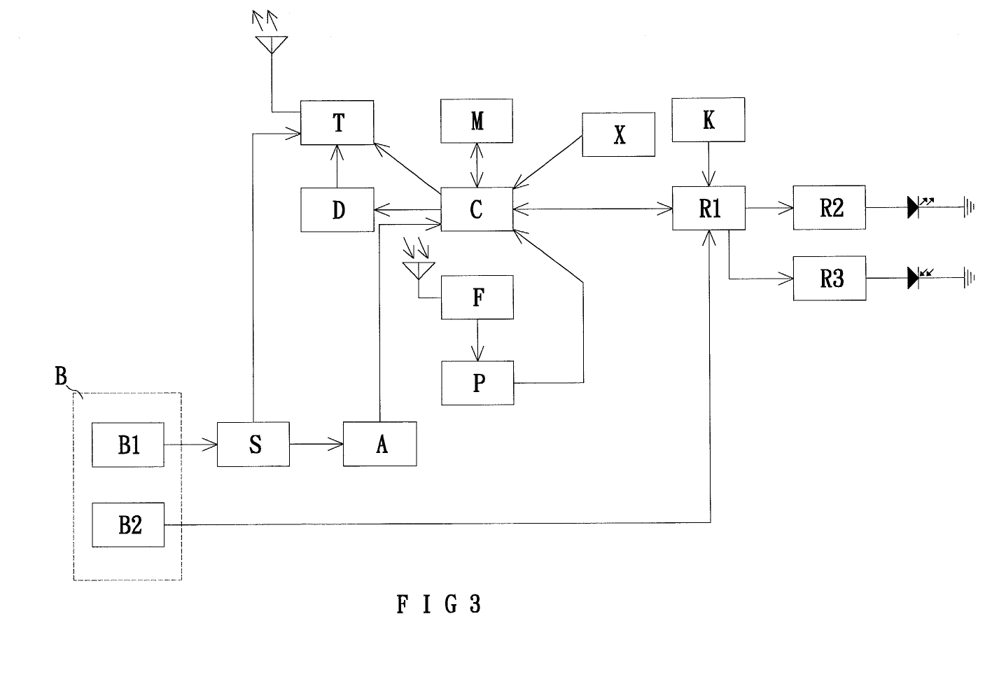

Referring to FIGS. 1 to 3, there is shown a remote control constructed in accordance with the invention. The remote control comprises a microprocessor C, a memory M, an oscillation generation circuit X, a high frequency signal and frequency receiver circuit F, a waveshaping circuit P, a digital to analog converter (DAC) D, a voltage controlled oscillation frequency transmission circuit T, a learning based infrared microprocessor control circuit R1, an infrared transmission circuit R2, an infrared receiver circuit R3, a key-in circuit K, a power supply circuit B, a light emitting diode (LED) indicator circuit L, a voltage rectification circuit for high frequency circuit A, and a high frequency circuit switch S. Each of above components will now be described below.

Microprocessor C serves to determine the pressed button through key-in circuit K, the frequency for high frequency wireless remote control, and sequentially change the sent frequency from DAC D until the frequency is equal to that of memory M for automatically calibrating frequency and performing a signal learning. Memory M is implemented as random access memory (RAM). Memory M is coupled to microprocessor C. Hence, signals sent from high frequency signal and frequency receiver circuit F may be stored in memory M for subsequent access by microprocessor C. Oscillation generation circuit X is an external oscillation circuit associated with microprocessor C for providing a stable operating frequency to microprocessor C. High frequency signal and frequency receiver circuit F serves to receive signals which are sent to microprocessor C for further processing during learning mode. Waveshaping circuit P serves to amplify the frequency of signal sent from high frequency signal and frequency receiver circuit F and send the amplified signal to microprocessor C for further processing. DAC D is commanded by microprocessor C to change voltage level and accordingly the frequency until which is equal to that of memory M. Voltage controlled oscillation frequency transmission circuit T is coupled to microprocessor C and DAC D respectively. In learning mode, various continuous frequencies are sent from DAC D to voltage controlled oscillation frequency transmission circuit T for controlling the output oscillation frequency thereof. Alternatively, a predetermined frequency may be sent from microprocessor C directly to voltage controlled oscillation frequency transmission circuit T in a remote control mode. Power supply circuit B comprises a high frequency transmission power supply circuit B1 for providing power required for high frequency transmission and an infrared transmission power supply circuit B2 for providing power required for infrared transmission circuit R2. Voltage rectification circuit for high frequency circuit A serves to provide a stable voltage for microprocessor C. Learning based infrared microprocessor control circuit R1 serves to receive code sent from a corresponding electrical device or copy code during high frequency wireless learning mode. Hence, it is possible for learning based infrared microprocessor control circuit R1 determining instructions sent from key-in circuit K, thereby controlling the electrical device to be activated through infrared transmission circuit R2. Infrared transmission circuit R2 is controlled by learning based infrared microprocessor control circuit R1 for transmitting infrared signals for controlling the electrical device. Alternatively, learning signals indicated by the flashing of LED may be transmitted from infrared transmission circuit R2 during learning. External infrared signals may be received by infrared receiver circuit R3. The received signals are then sent to learning based infrared microprocessor control circuit R1. High frequency circuit switch S serves to switch between high frequency transmission and infrared transmission. With this remote control, it is possible to perform learning, high frequency remote control, or infrared remote control as detailed below.

Operation:

In infrared learning (i.e., copy) mode, the remote control of the invention may be operated as typical code setting or copying. As shown in FIG. 1 specifically, for example, when setting a TV code through infrared remote control, first press “SET” button and then press “TV” button. Consequently, LED associated with infrared transmission circuit R2 is flashing for several seconds prior to dimming. This completes a first step of TV code learning. Then release “SET” and “TV” buttons at the same time. Thus learning based infrared microprocessor control circuit R1 is in a waiting state for preparing to receive a TV code input. Once a TV code (e.g., numeral 157 assigned to General Electric (GE) TV) is keyed in, learning based infrared microprocessor control circuit R1 immediately acknowledges the receiving. Thus completes the remote setting of TV Above procedure is applicable to set any of other electrical devices by infrared. A new code may be set by performing above procedure again. Another technique of infrared learning is to press, for example, “SET” button and numeral “1” button, or “SET” button twice in a short period of time. Hence, learning based infrared microprocessor control circuit R1 is commanded to enter a learning state. Consequently, LED associated with infrared transmission circuit R3 is flashing for indicating an activation of learning mode. The next step is waiting for copying. First, align a target remote control to be copied with the remote control of the invention. Then press a code corresponding to an electrical device (e.g., “TV” button on the target remote control). At the same time, press “TV” button on the remote control of the invention. Hence, infrared receiver circuit R3 in the remote control of the invention is receiving the signals while the target remote control is transmitting the same (i.e., learning). Further, TV code is inputted into learning based infrared microprocessor control circuit R1 (i.e., learning completed). User may perform the same procedure to delete the copied code.

As to high frequency wireless learning technique, first switch high frequency circuit switch S to high frequency operating mode for activating voltage controlled oscillation frequency transmission circuit T. Then microprocessor C receives commands from infrared transmission circuit R2 through learning based infrared microprocessor control circuit R1. Next user is required to press buttons in the learning mode. For example, press two buttons (e.g., “SET” and one of numeral keys) at the same time to cause microprocessor C to enter into learning state. Also, user is informed the same by, for example, the flashing of LED indicator circuit L. Further, high frequency signal and frequency receiver circuit F and waveshaping circuit P are enabled to prepare to receive high frequency signals. When signals have been transmitted by the target remote control (to be copied), the same signals are received by high frequency signal and frequency receiver circuit F. The received signals are divided prior to sending to waveshaping circuit P. High frequency signals and high frequency oscillation frequencies are generated in waveshaping circuit P. Then the same are sent to microprocessor C for further processing prior to sening to memory M for storage. This procedure is done within one second. Once done, user may release buttons. This completes the learning. Next it is to convert the received signals into one corresponding to a specified button of an electrical device. First press a desired button to cause LED indicator circuit L to flash as designed. For example, a continuous lighting of LED means to inform user to prepare to enter into setting mode. Further, microprocessor C reads previously stored data from memory M. High frequency signal and frequency receiver circuit F and waveshaping circuit P are also enabled. The voltage required for the remote control of the invention is generated in DAC D by microprocessor C wherein the output value of DAC D is sequentially changed. Furthermore, signals transmitted from voltage controlled oscillation frequency transmission circuit T are received by high frequency signal and frequency receiver circuit F. The received signals are amplified by waveshaping circuit P. The amplified signals are then sent to microprocessor C for comparison with data (i.e., previously stored in memory M) accessed from memory M. This comparison continues until they have the same frequency. LED is dimmed once the comparison is done. This achieves the purpose of automatic frequency calibration and signal learning. A learning of a next high frequency of the target remote control corresponding to the electrical device to be controlled may be achieved by performing the above procedure again.

Following is a description of resetting the control button of a corresponding electrical device. First, it is required to delete the previous setting. As designed, simultaneously or sequentially press the desired buttons (e.g., “TV” and “SET” buttons). Then LED indicator circuit L is flashing twice for indicating the previous setting has been deleted. Accordingly, user may begin to operate the remote control of the invention to learn (i.e., copy). Preferably, this learning process may be the same as the one described above for simplifying the operation. In use, user may first switch high frequency circuit switch S to a desired infrared or high frequency wireless mode. Then press the button corresponding to the electrical device to be controlled.

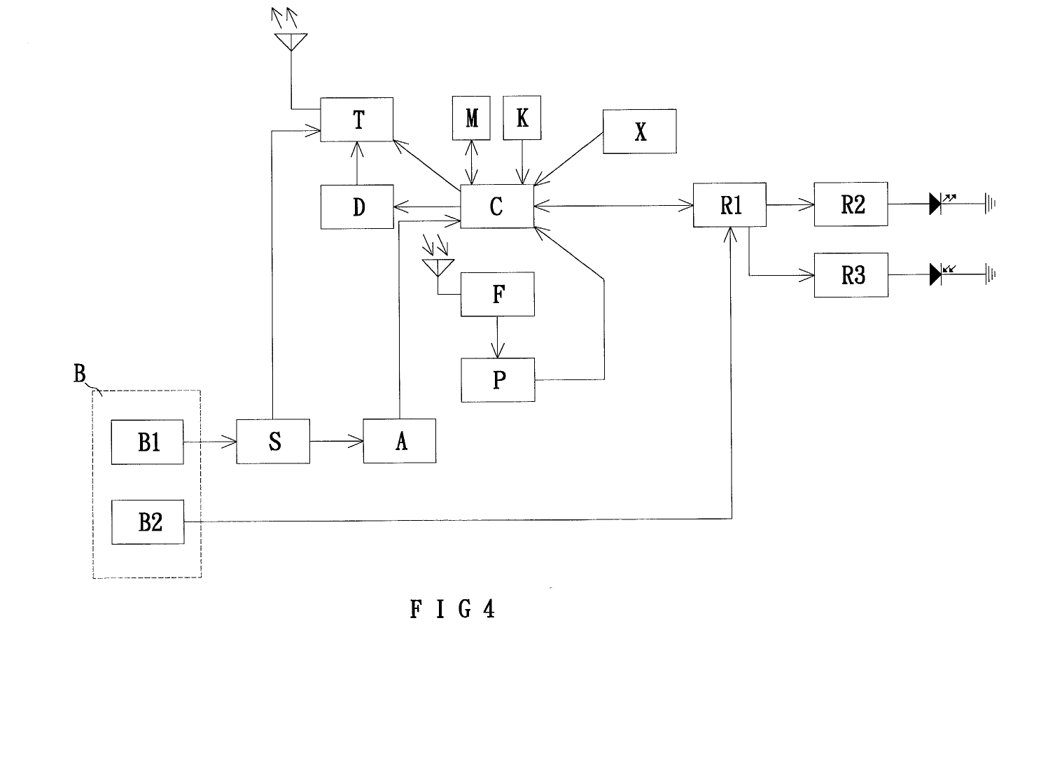

Referring to FIG. 4, there is shown a second embodiment of the remote control of the invention wherein key-in circuit K is directly coupled to microprocessor C. This may further simplify operation. Operation: Once the desired button is pressed, microprocessor C is activated to issue an instruction to a corresponding electrical device (e.g., TV, fan, or electric lock) through infrared or wireless for effecting a remote control. Preferably, the learning procedure of infrared or wireless remote control is easy to understand for facilitating setting. In one configuration, microprocessor C and buttons are modified as follows: A pair of set buttons (e.g., “SET1” and “SET2”) are provided. Alternatively, a common set button (“SET”) and an identification button are provided. For example, the identification button may be set as “SET+1” for infrared setting. Microprocessor C may determine whether the remote control of the invention is operated through infrared from the input signal. If yes, learning based infrared microprocessor control circuit R1 is enabled. Thus, the remote control of the invention enters into key-in mode or learning mode for copying code. If the key-in mode is desired, user may press the button corresponding to the electrical device to be controlled. Next, release the button. Hence learning based infrared microprocessor control circuit R1 enters into the key-in mode. Then input a code (e.g., numeral 029 assigned to GE TV). As a result, the key-in process is finished. As to learning mode, press the button to be copied continuously. Then LED associated with infrared receiver circuit R3 is lit after several seconds (e.g., two seconds) by the enabled learning based infrared microprocessor control circuit R1. This indicates that signals sent from the target remote control are being received. The learning process is finished once the LED is dimmed. As to wireless learning mode, it is designed to press “SET+2” for switching. Then, microprocessor C enters into learning state. Once the “CF” button to be copied is pressed for controlling the fan, microprocessor C will instruct high frequency signal and frequency receiver circuit F to receive signals sent from the target remote control for entering into above high frequency learning mode.

While the invention has been described by means of specific embodiments, numerous modifications and variations could be made thereto by those skilled in the art without departing from the scope and spirit of the invention set forth in the claims.

What is claimed is:

1. A circuit assembly for a remote control, comprising a microprocessor, a memory, an oscillation generation circuit, a high frequency signal and frequency receiver circuit, a waveshaping circuit, a digital to analog converter (DAC), a voltage controlled oscillation frequency transmission circuit, a learning based infrared microprocessor control circuit, an infrared transmission circuit, an infrared receiver circuit, a key-in circuit, a power supply circuit, a light emitting diode (LED) indicator circuit, a voltage rectification circuit for high frequency circuit, and a high frequency circuit switch wherein said microprocessor is operable to determine a signal from said enabled key-in circuit, a frequency for high frequency wireless remote control, and sequentially change a frequency from said DAC until said frequency is equal to that of said memory for automatically calibrating frequency and performing a signal learning; said memory is implemented as random access memory (RAM), said memory is coupled to said microprocessor for storing signals sent from said high frequency signal and frequency receiver circuit for subsequent access by said microprocessor; said oscillation generation circuit is operable to provide a stable operating frequency to said microprocessor; said high frequency signal and frequency receiver circuit is operable to receive signals and send said same to said microprocessor for processing in a learning mode; said waveshaping circuit is operable to amplify said signals sent from said high frequency signal and frequency receiver circuit and send said amplified signals to said microprocessor for processing; said DAC is commanded by said microprocessor to change voltage level and accordingly said frequency of said signals until which is equal to that stored in said memory; said voltage controlled oscillation frequency transmission circuit is coupled to said microprocessor and said DAC respectively wherein during learning, various continuous frequencies are sent from said DAC to said voltage controlled oscillation frequency transmission circuit for controlling said output oscillation frequency thereof, or a signal having a predetermined frequency is sent from said microprocessor directly to said voltage controlled oscillation frequency transmission circuit in a remote control mode; said power supply circuit is operable to provide power required for high frequency transmission and infrared transmission circuit respectively; said voltage rectification circuit for high frequency circuit serves to provide a stable voltage for said microprocessor; said learning based infrared microprocessor control circuit is operable to receive code sent from a corresponding electrical device or copy code during a high frequency wireless learning mode for enabling said learning based infrared microprocessor control circuit to determine instructions sent from said key-in circuit and controlling said electrical device to be activated through said infrared transmission circuit; said infrared transmission circuit is controlled by said learning based infrared microprocessor control circuit for transmitting infrared signals to control said electrical device, or learning signals indicated by said flashing of said LED indicator circuit are transmitted from said infrared transmission circuit during said learning mode; said infrared receiver circuit is operable to receive said infrared signals and send said same to said learning based infrared microprocessor control circuit; and said high frequency circuit switch is operable to switch between a high frequency transmission and an infrared transmission.

2. The circuit assembly of claim 1, wherein said key-in circuit is directly coupled to said microprocessor whereby a button on said remote control is pressed, said microprocessor is activated to issue an instruction to said corresponding electrical device through infrared or wireless for effecting a control.
